(19) United States
(12) Patent Application Publication
(10) Pub. No.: US 2014/0090599 A1
(43) Pub. Date: Apr. 3, 2014

(54) FILM FORMING APPARATUS

(71) Applicant: TOKYO ELECTRON LIMITED, Minato-ku (JP)

(72) Inventor: Tetsuya SAITOU, Yamanashi (JP)

(73) Assignee: TOKYO ELECTRON LIMITED, Minato-ku (JP)

(21) Appl. No.: 14/030,422

(22) Filed: Sep. 18, 2013

(30) Foreign Application Priority Data
Sep. 28, 2012 (JP) 2012-217035

(51) Int. Cl. B05B 1/00

(52) U.S. Cl. CPC B05B 1/005
USPC 118/728

(57) ABSTRACT

A film forming apparatus performs a film forming process by supplying a plurality of types of reactant gases that react with one another to a substrate in a processing chamber in a vacuum atmosphere. The apparatus includes: a ceiling part provided to face a mounting table and having an inclined surface that is wider gradually from a center toward a periphery; gas supply units provided at a central area of the ceiling part, each of the gas supply units having gas discharge openings formed around a circumferential direction thereof; and a shower head disposed to cover the gas supply units. The shower head has gas supply openings in a bottom portion thereof opposite to the mounting table. An outer periphery of the shower head is located inward of an outer periphery of the substrate mounted on the mounting table.

### CROSS-REFERENCE TO RELATED APPLICATIONS

This application claims priority to Japanese Patent Application No. 2012-217035 filed on Sep. 28, 2012, the entire contents of which are incorporated herein by reference.

### FIELD OF THE INVENTION

The present invention relates to a film forming apparatus for forming a film by sequentially supplying a plurality of types of reactant gases that react with one another to a substrate.

### BACKGROUND OF THE INVENTION

As for a method for forming a film on a substrate, e.g., a semiconductor wafer (hereinafter, referred to as “wafer”,) there is known a so-called ALD (Atomic Layer Deposition) method for sequentially supplying a plurality of types of reactant gases that react with one another to a wafer, a MLD (Multi Layer Deposition) method (hereinafter, both will be referred to as “ALD methods”), or the like.

In such a film forming method, there are suggested various gas supply mechanism for supplying a reactant gas to a wafer. For example, Japanese Patent Application Publication Nos. 2002-327274 and 2006-299294 disclose a shower head having vertically stacked gas diffusion spaces (spaces 11a and 11b in JP2002-327274A and a gas diffusion space 50 and a space 81 in JP2006-299294A) partitioned by an intermediate shower plate among a plurality of plates disposed in multiple stages in a vertical direction at an interval and a plurality of gas channels that is opened in a bottom surface of a lowermost shower plate from the respective diffusion spaces.

In the shower head of the above type, a plurality of types of reactant gases are supplied from the gas diffusion spaces separated from one another. Therefore, the reactant gases are not mixed in the gas diffusion spaces, and the deposition of reaction products to the shower head can be prevented.

Meanwhile, in order to supply reactant gases from the vertically stacked gas diffusion spaces without being mixed with each other, it is required to provide a plurality of lines for gas channels which communicate with the upper gas diffusion space while passing through the lower gas diffusion space, which makes the structure of the shower head complicated.

Therefore, the present applicant is developing a simple shower head for selectively supplying a plurality of types of reactant gases into a common gas diffusion space. In the case of using a common gas diffusion space, in order to prevent deposition of reaction products, gas replacement needs to be performed by supplying an inert gas or the like between supply of a single reactant gas and supply of a next reactant gas.

When the reactant gases are replaced, time required for the replacement operation should be minimized in order to effectively perform film formation. Recently, a deposited film of nanometer order may require thickness uniformity (e.g., a M−m value to be described later) of about 5% or less in the wafer surface. Therefore, it is required to develop a shower head capable of providing advantage of replacement and realizing film formation while ensuring excellent in-plane uniformity.

In respond to the above demand, the shower head disclosed in Japanese Patent Application Publication Nos. 2002-327274 and 2006-299294 has a large gas diffusion space extending over a region corresponding to the entire surface of the wafer. Even if reactant gases and a replacement gas are selectively supplied to one side of the gas diffusion space, a long period of time is required for the replacement operation.

Further, Japanese Patent Application Publication Nos. 2002-327274 and 2006-299294 disclose gas supply units for supplying reactant gases into the gas diffusion spaces (gas injection openings 12l formed in a tube portion 10j in JP2002-327274A, a gas injection port 56 having gas injection openings 55 and a gas injection line 83 in JP2006-299294A). However, there is no description on technical features that are required to the gas supply units to improve uniformity of a film to be formed in the shower head for selectively supplying the reactant gases and the replacement gas.

The present applicant has developed a film forming apparatus (referred to as “gas supply nozzle” in Japanese Patent Application Publication No. 2009-224775) that improves the replacement by providing a shower head smaller than that of a wafer as a film formation target at a central area of a ceiling portion having an inclined surface that is gradually wider from a center toward a periphery as disclosed in JP2009-224775A.

However, a flow speed of a reactant gas injected through from a gas supply opening positioned immediately below a gas supply line for introducing a gas into the shower head among a plurality of gas supply openings formed in the shower head may be increased compared to other such a position. As a result, the difference in the flow speed of the gas injected through the gas supply openings leads to the difference in the amount of reactant gas adsorbed onto the wafer, and the film thickness may be slightly varied in the surface of the wafer. However, if a high in-plane uniformity of M−m value of about 5% or less, is required as described above, even the slight difference in the film thickness needs to be improved.

### SUMMARY OF THE INVENTION

In view of the above, the present invention provides a film forming apparatus capable of forming a film having good in-plane uniformity and ensuring rapid replacement between reactant gases and a replacement gas.

In accordance with a film forming apparatus of the present invention, there is provided a plurality of types of reactant gases that react with one another to a substrate in a processing chamber in a vacuum atmosphere and supplying a replacement gas between supply of one of the reactant gases and supply of a next one of the reactant gases, the apparatus comprising: a mounting table provided in the processing chamber, the mounting table serving to mount thereon a substrate; a ceiling part provided to face the mounting table, the ceiling part having an inclined surface that is wider gradually from a center portion toward a periphery; a plurality of gas supply units provided at a central area of the ceiling part, each of the gas supply units having gas discharge openings formed along a circumferential direction thereof; a shower head disposed to cover the gas supply units from below, the shower head having a plurality of gas supply openings in a bottom portion thereof opposite to the mounting table; and a gas exhaust unit configured to evacuate the processing chamber, wherein an outer periphery of the shower head is located inward of an outer periphery of the substrate mounted on the mounting table.

The film forming apparatus described above may have the follow features.

(a) The gas discharge ports formed at the gas supply units are disposed such that a gas flowing through the gas discharge ports is diffused toward a central portion and a peripheral portion of the shower head when seen in a plan view.

(b) The number of the gas supply units is three or more, and the gas supply units are provided along a circumferential direction of the shower head.

(c) The shower head includes a sidewall portion provided along an outer periphery of the bottom portion opposite to the mounting table, and the sidewall portion has a plurality of gas supply openings for horizontally supplying a gas in a shower shape.

(d) The substrate has a circular plate shape; the bottom portion has a circular shape when seen in a plan view; and on the assumption that a radius of the substrate is R and a radius of the bottom portion is r, r/R is greater than or equal to 4/15 and smaller than or equal to ⅔.

### BRIEF DESCRIPTION OF THE DRAWINGS

The objects and features of the present invention will become apparent from the following description of embodiments, given in conjunction with the accompanying drawings, in which:

FIG. 1 is a vertical cross sectional view of a film forming apparatus in accordance with a first embodiment the present invention;

FIG. 2 is an enlarged vertical cross sectional view of the film forming apparatus;

FIG. 3 is a perspective view of a ceiling plate provided at the film forming apparatus;

FIG. 4 is a vertical cross sectional view of a gas supply unit provided at the ceiling plate;

FIG. 5 is a horizontal top view of a shower head which shows arrangement of gas supply units;

FIG. 6 is a first explanatory view showing an operation of the film forming apparatus;

FIG. 7 is a second explanatory view showing an operation of the film forming apparatus;

FIG. 8 is a horizontal top view of a shower head which shows another arrangement of the gas supply units;

FIG. 9 is a perspective view of a ceiling plate of a film forming apparatus in accordance with a second embodiment of the present invention;

FIG. 10 is a vertical cross sectional view of a film forming apparatus in accordance with the second embodiment of the present invention;

FIG. 11 is a vertical cross sectional view of a film forming apparatus in accordance with a third embodiment of the present invention;

FIG. 12 is a vertical cross sectional view of a film forming apparatus in accordance with a fourth example of the present invention;

FIG. 13 is a vertical side view of a film forming apparatus of a comparative example;

FIG. 14 is a first explanatory view showing a film forming result of a test example;

FIG. 15 is a second explanatory view showing a film forming result in the test example; and

FIG. 16 is an explanatory view showing a film forming result in the comparative example.

### DETAILED DESCRIPTION OF THE EMBODIMENTS

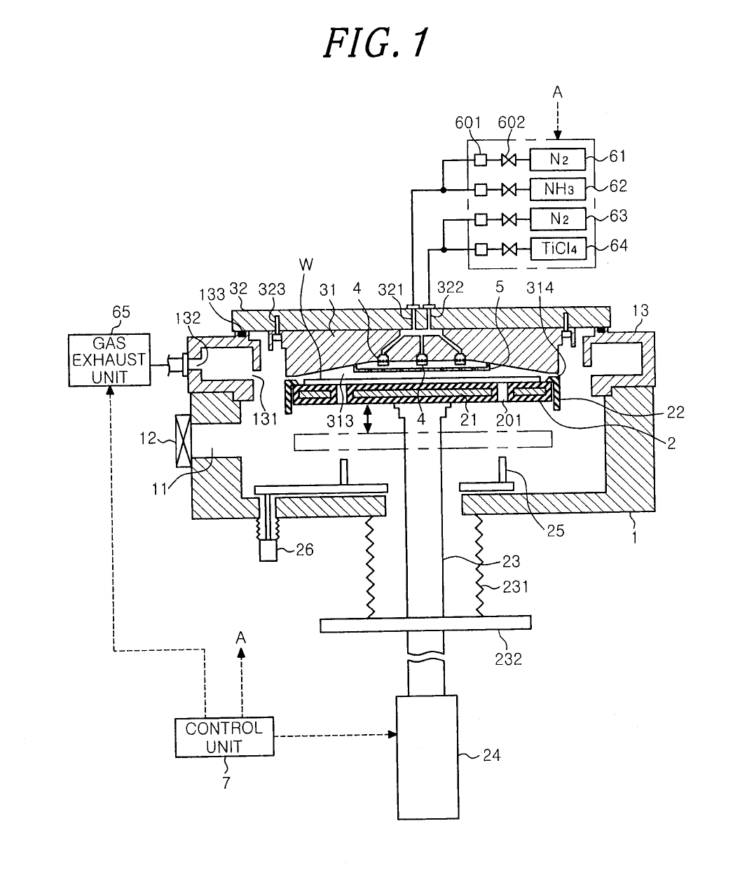

A configuration of a film forming apparatus in accordance with an embodiment of the present invention will be described with reference to FIGS. 1 to 5. This film forming apparatus is configured as an apparatus for forming a titan nitride (TiN) film by an ALD method for alternately supplying titanium chloride (TiCl₄) gas (source gas) and ammonia (NH₃) gas (nitriding gas) as reactant gases that react with each other to a surface of a circular substrate (circular plate) as a film formation target, e.g., a wafer W having a diameter of 300 mm.

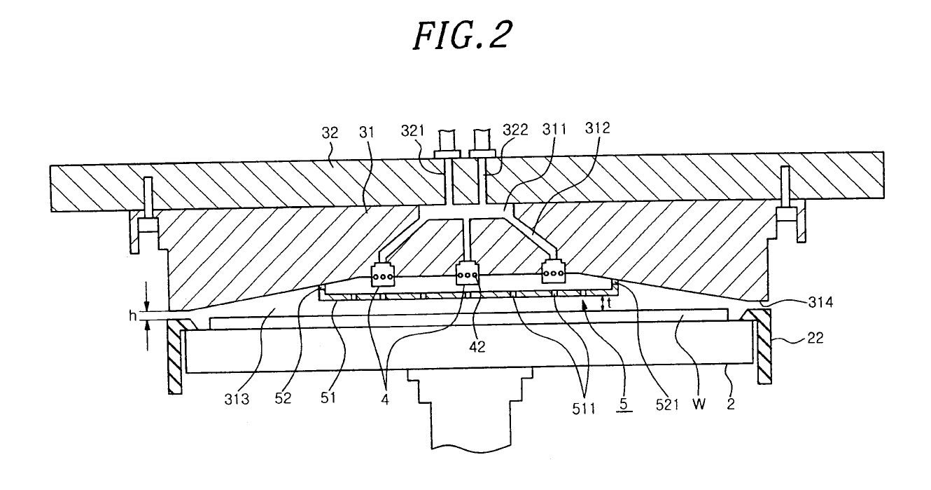

As shown in FIGS. 1 and 2, the film forming apparatus includes: a processing chamber 1 that is a vacuum container made of a metal such as aluminum or the like and having an approximately circular shape when seen from the top; a mounting table (mounting part) 2, provided in the processing chamber 1, for mounting thereon a wafer W; and a ceiling plate member 31 disposed opposite to the mounting table 2 form a processing space 313 between itself and the mounting table 2. Provided at a side wall of the processing chamber is a loading/unloading port 11 for allowing a wafer transfer unit provided in an external vacuum transfer chamber to enter the processing chamber 1 during transfer of the wafer W to and from the mounting table 2 and a gate valve 12 for opening and closing the loading/unloading port 11.

An annular gas exhaust duct 13 made of a metal such as aluminum or the like and having a substantially rectangular vertical cross section is provided at a position above the loading/unloading port 11 to be placed on the sidewall of the processing chamber 1. A slit-shaped opening 131 extending along the circumferential direction is formed at an inner peripheral surface of the gas exhaust duct 13, and a gas flowing from the processing space 313 is discharged into the gas exhaust duct 13 through the opening 131. A gas exhaust port 132 is formed at an outer wall surface of the gas exhaust duct 13, and a gas exhaust unit 65 including a vacuum pump or the like is connected to the gas exhaust port 132. The gas exhaust port 132 and the gas exhaust unit 65 correspond to a gas exhaust part for performing vacuum evacuation of the processing space 313.

In the processing chamber 1, the mounting table 2 is provided at a position inward of the gas exhaust duct 13. The mounting table 2 is a circular plate larger than a wafer W and made of, e.g., ceramics such as aluminum nitride AlN, quartz glass SiO₂ or the like, or a metal such as aluminum Al, hastelloy (Registered Trademark) or the like. A heater 21 for heating a wafer W to a film forming temperature of, e.g., about 350° C. to 450° C., is embedded in the mounting table 2. If necessary, an electrostatic chuck (not shown) for holding the wafer W in a mounting area of the top surface of the mounting table 2 may be provided. The illustration of the heater 21 is omitted in the vertical cross sectional views other than FIG. 1.

A cover member 22 is provided at the mounting table 2 so as to cover the outer peripheral region of the mounting region and the side peripheral surface of the mounting table 2 in the circumferential direction. The cover member 22 is made of, e.g., alumina or the like, and has an approximately cylindrical shape having an upper and a lower opening. The upper end portion thereof is bent inwardly in a horizontal direction over the circumferential direction. The bent portion is engaged with the peripheral portion of the mounting table 2. The thickness of the bent portion is greater than the thickness (0.8 mm) of the wafer W, and is within a range of about 1 mm to 5 mm, preferably about 3 mm, for example.

A supporting member 23 extending through the bottom wall of the processing chamber 1 in a vertical direction is connected to the central portion of the bottom surface of the mounting table 2. The lower end portion of the supporting member 23 is connected to an elevation unit 24 via a plate-shaped support plate 232 disposed horizontally below the processing chamber 1. The elevation unit 24 vertically moves the mounting table 2 between a transfer position (indicated by dashed dotted line in FIG. 1) where the wafer W is transferred between the mounting table 2 and the wafer transfer unit introduced through the loading/unloading port 11 and a processing position, above the transfer position, where the film formation is performed on the wafer W.

A bellows 231 that partitions an atmosphere in the processing chamber 1 from the outside and extends/contracts in accordance with the vertical movement of the supporting plate 232 is provided between the supporting plate 232 and the bottom wall of the processing chamber 1 to circumferentially cover the supporting member 23 at the outer side thereof.

Provided below the mounting table 2 are, e.g., three supporting pins 25 for supporting and lifting the wafer W from the bottom surface side during the transfer of the wafer W between the mounting table 2 the wafer transfer unit. The supporting pins 25 are connected to the elevation unit and vertically movable by being transfer the wafer. W between the mounting table and the wafer transfer unit while protruding beyond or retracting below the top surface of the mounting table 2 through holes 201 extending through the mounting table 2 in a vertical direction.

A circular holding plate 32 is provided on the top surface of the gas exhaust duct 13 to cover the circular opening, and an O ring 133 for airtightly maintaining the processing chamber 1 is provided between the gas exhaust duct 13 and the supporting plate 32. A ceiling plate 31 for supplying reactant gases and a replacement gas into the processing space 313 is provided at the bottom surface side of the holding plate 32. The ceiling plate 31 is hold and fixed to the holding plate 32 by bolts 323.

A recess is formed in the bottom surface of the ceiling plate 31 and has a flat central region. An inclined surface that is gradually wider from a central side toward a peripheral side is formed at an outer peripheral side of the flat central region. A flat rim 314 is provided at a further outer side of the inclined surface.

The ceiling plate 31 is disposed such that the bottom surface of the rim 314 faces the top surface of the cover member 22 provided at the mounting table 2 when the mounting table 2 is raised to the processing position. The space surrounded by the recess of the ceiling plate 31 and the top surface of the mounting table 2 becomes the processing space 313 where the wafer W is subjected to film formation. The ceiling plate 31 having the recess constitutes a ceiling part of the film forming apparatus.

As shown in FIG. 2, the height level of the processing position is set such that a gap having a height h is formed between the bottom surface of the rim 314 of the ceiling plate 31 and the top surface of the bent portion of the cover member 22. The opening 131 of the gas exhaust duct 13 opens toward the gap. The height h of the gap between the rim 314 and the cover member 22 is set to, e.g., a range of 0.2 mm to 10.0 mm, preferably about 0.5 mm.

The shower head 5 is provided at the central region of the bottom surface of the ceiling plate 31 so as to cover the aforementioned flat region and a part of the inclined surface at the outer peripheral side thereof. The shower head 5 includes: a bottom portion 51 that is, e.g., a metallic circular plate, disposed opposite to the mounting table 2; and a sidewall portion 52 provided along the outer periphery of the bottom portion 51. The shower head 5 is a tray-shaped member having an upper opening. In the shower head 5 of the present embodiment, a diameter of the shower head 5 is set to about 166 mm (radius of 83 mm): a distance in a height direction from the bottom surface of the flat region of the ceiling plate 31 to the top surface of the bottom portion 51 is set to 8.5 mm; and a volume in the shower head 5 except a volume of the gas supply unit 4 to be described later is set to 146.5 cm³. For example, a flange (not shown) is provided at an upper end portion of the sidewall portion 52, and the shower head 5 is fixed to the ceiling plate 31 through the flange by screws or the like.

When the shower head 5 having the bottom portion 51 having a diameter of 166 mm (radius of 83 mm) is disposed above the central portion of the wafer W having a diameter of 300 mm (radius of 150 mm) which is mounted on the mounting table 2, the outer periphery of the shower head (outer periphery of the bottom portion 51) is located inward of the outer periphery of the wafer W. By using the shower head 5 smaller than the wafer W, the replacement of the reactant gases by the replacement gas can be performed in a short period of time.

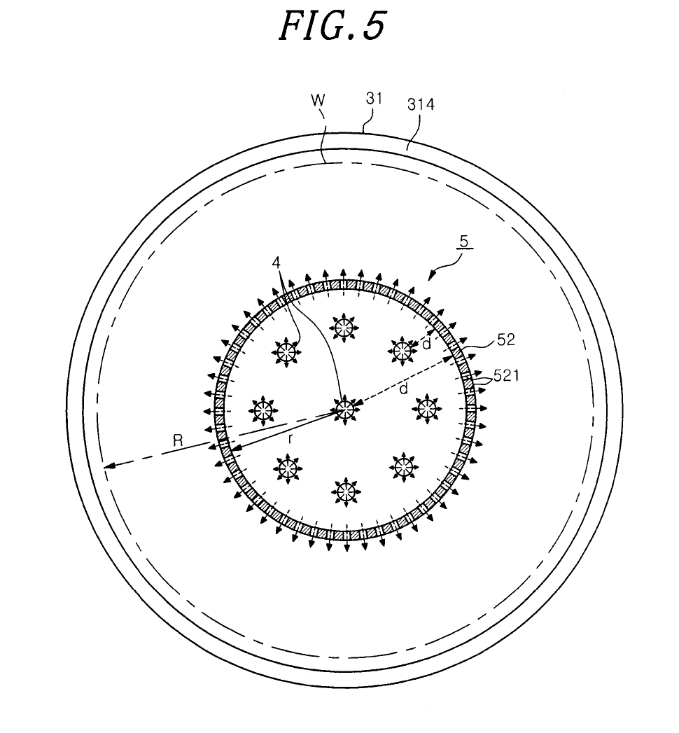

As shown in FIG. 5, on the assumption that the radius of the shower head 5 is r and the radius of the wafer W is R, a value of r/R is preferably in the range of 4/15 to ⅔. Further, the height and the volume of the inside of the shower head 5 are preferably 3 mm to 10 mm, and 30 cm³ to 245 cm³, respectively. By supplying the replacement gas of an amount 2 to 5 times greater than the above volume at a flow rate of 2 L/min to 6 L/min into the shower head 5, the replacement operation can be completed in 0.1 sec to 0.5 sec.

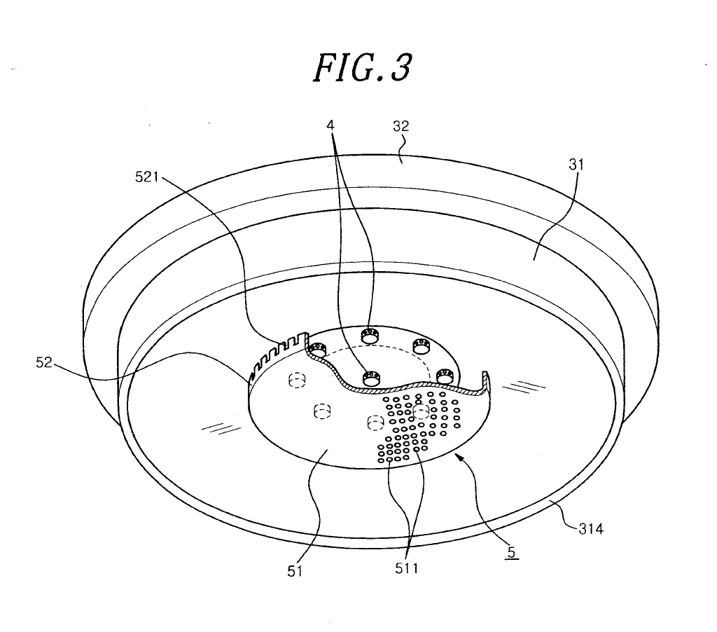

As shown in FIG. 3, a plurality of gas supply openings 511 is formed in the entire surface of the bottom portion 51, so that the reactant gases can be supplied toward the wafer W mounted on the mounting table 2. Further, a plurality of slit-shaped gas supply openings 521 is formed in the sidewall portion 52 along the periphery of the sidewall portion 52 at regular intervals, so that the reactant gases can be discharged in a horizontal direction. In case the gas supply can be uniformly supplied into the processing space 313 by forming the gas supply openings 511 at least in the bottom portion 51, the gas supply openings 521 may not be formed in the sidewall portion 52. Further, it is not necessary to form the gas supply openings 511 in the entire surface of the bottom portion 51, and the gas supply openings 511 may be formed at, e.g., the central region of the bottom portion 51 as long as the time for replacing the gas in the shower head 5 and the uniformity of the film formed on the wafer W are satisfied. In FIG. 3, for convenience, only a part of the gas supply openings 511 formed in the entire surface of the bottom portion 51 is illustrated.

The height t (corresponding to a distance from the top surface of the wafer W to the bottom surface of the bottom portion 51 in the case where the bottom portion 51 is a flat plate) from the top surface of the wafer W on the mounting table 2 to the gas supply openings 511 of the bottom portion 51 is set to 10 mm to 50 mm, and preferably 15 mm to 20 mm. If the height exceeds 50 mm, the gas replacement efficiency is decreased. On the other hand, if the height becomes smaller than 10 mm, a space for the gas supply unit 4 and the shower head 5 does not exist, or it is difficult for the gas to flow in the processing space 313.

Nine gas supply units 4 including one gas supply unit 4 disposed at a central portion of the recess and eight gas supply units 4 circumferentially arranged at regular intervals around the central portion are provided at the central region of the bottom surface of the ceiling plate 31 which is covered by the bottom portion 51, as shown in FIGS. 3 and 5. Here, the number of the gas supply units 4 disposed at the inner side of the bottom portion 51 is not limited to nine. For example, when at least two and preferably three or more gas supply units 4 are provided along the circumferential direction of the shower head 5, the gas can be uniformly supplied into the shower head 5 in a short period of time.

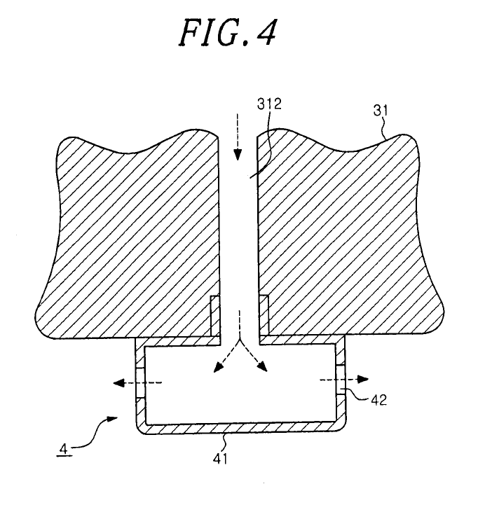

As shown in FIG. 4, each of the gas supply units 4 has a structure in which a lower opening of a gas supply path 312 formed through the ceiling plate 31 is covered by a cylindrical hollow head portion 41. The head portion 41 is downwardly protruded from the bottom surface of the ceiling plate 31, and a plurality of gas discharge openings 42 circumferentially arranged at regular intervals is formed in the side wall of the head portion 41. Each of the head portion 41 preferably has, e.g., three or more gas discharge openings 42. In this example, eight gas discharge openings 42 are provided. Moreover, the bottom of the head portion 41 is closed by the bottom wall having no gas discharge openings 42. Therefore, the gas flowing into the head portion 41 is horizontally uniformly discharged through the gas discharge openings 42.

As described above, the gas supply unit 4 is configured to uniformly diffuse the gas in a radial direction. The gas discharged through the gas discharge openings 42 of the gas supply unit 4 is sufficiently diffused in the shower head 5 and then supplied to the processing space 313 through the gas supply openings 511 and 521. Accordingly, the gas is uniformly supplied to the surface of the wafer W on the mounting table 2. When the gas supply unit 4 is disposed near the sidewall portion 52 of the shower head 5, the gas discharged from the gas supply unit 4 passes through the gas supply opening 521 of the sidewall portion 52 and, thus, a sufficient amount of gas is not supplied to the bottom portion 51. Accordingly, the deviation may occur in the flow of the gas supplied from the bottom portion 51.

Further, even when the gas supply openings 521 are not provided at the sidewall portion 52, if the gas discharged from the gas supply unit 4 powerfully collides with the inner wall surface of the sidewall portion 52 and the gas whose flow direction has been changed is supplied into the processing space 313 through the gas supply openings 511 of the bottom portion 51, a deviation in gas flow speed occurs between the gas supplied through the gas supply openings 511 at the peripheral portion and the gas supplied through the gas supply openings 511 at the central portion where the gas flow speed is sufficiently reduced. In that case as well, the deviation occurs in the gas flow, and this may adversely affect the in-plane uniformity of the film formed on the wafer W.

Here, the gas supply unit 4 of the present embodiment is separated from the inner wall surface of the sidewall portion 52 (corresponding to the outer periphery of the shower head 5 in the present embodiment) toward the center of the recess formed at the bottom surface of the ceiling plate 31. Since the gas discharge openings 42 are uniformly formed along the side wall of the head portion 41, the flow of the gas diffused toward the central portion and the peripheral portion of the shower head 5 is formed when the shower head 5 is seen from the top as illustrated in FIG. 5. Here, when the distance d from the inner wall surface of the sidewall portion 52 to the gas supply unit 4 is, e.g., 10 mm to 30 mm, the flow speed of the gas discharged through the gas discharge openings of the gas supply unit 4 can be sufficiently decreased and the gas can be uniformly supplied through the gas supply openings 511 and 512 of the shower head 5.

As shown in FIGS. 1 and 2, the ceiling plate 31 having the gas supply units 4 is provided with the gas supply paths 312 for supplying gases to the gas supply units 4. The gas supply paths 312 are connected to the gas diffusion space 311 defined between the top surface of the ceiling plate 31 and the bottom surface of the supporting plate 32.

The holding plate 32 has an ammonia gas supply hole 321 for supplying ammonia gas and nitrogen gas for substitution into the diffusion space 311, and a titanium chloride gas supply hole 322 for supplying titanium chloride gas and nitrogen gas for replacement into the diffusion space 311. The ammonia gas supply hole 321 and the titanium chloride gas supply hole 322 are connected to the ammonia gas supply unit 62 and the titanium chloride gas supply unit 64 via lines, and these lines are branched and connected to nitrogen gas supply units 61 and 63. Each of the lines is provided with a flow rate control unit 601 for adjusting a gas supply amount and an opening/closing valve 602 for allowing and stopping supply of a gas. For convenience, the nitrogen gas supply units 61 and 63 are illustrated separate in FIG. 1. However, a common nitrogen supply source may be used.

The film forming apparatus configured as described above is connected to a control unit 7, as shown in FIG. 1. The control unit 7 includes a computer having, e.g., a CPU and a storage unit (both not shown). The storage unit stores therein a program including the operation of the film forming apparatus, i.e., control steps (commands) of raising the wafer W mounted on the mounting table 2 to the processing position, forming a TiN film by supplying reactant gases and a replacement gas into the processing space 313 in a predetermined sequence, and unloading of the wafer W that has been subjected to the film formation. This program is stored in a storage medium, e.g., a hard disk, a compact disk, a magnet optical disk, a memory card or the like, and installed in a computer.

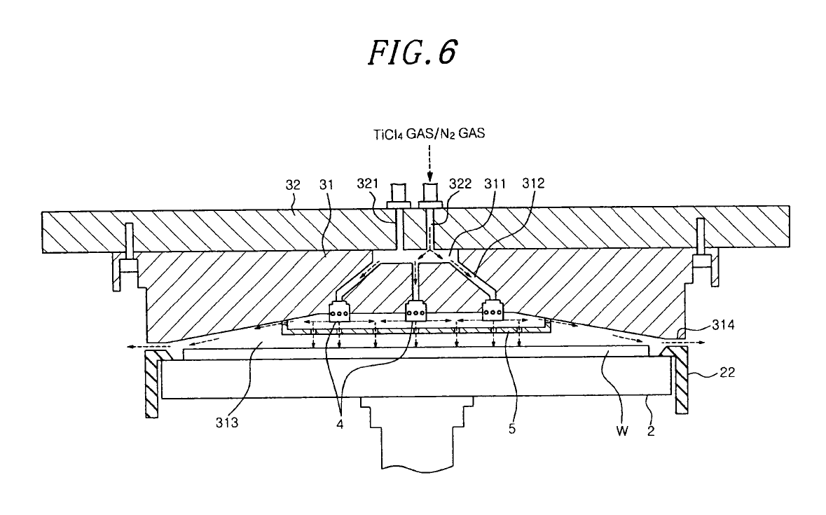

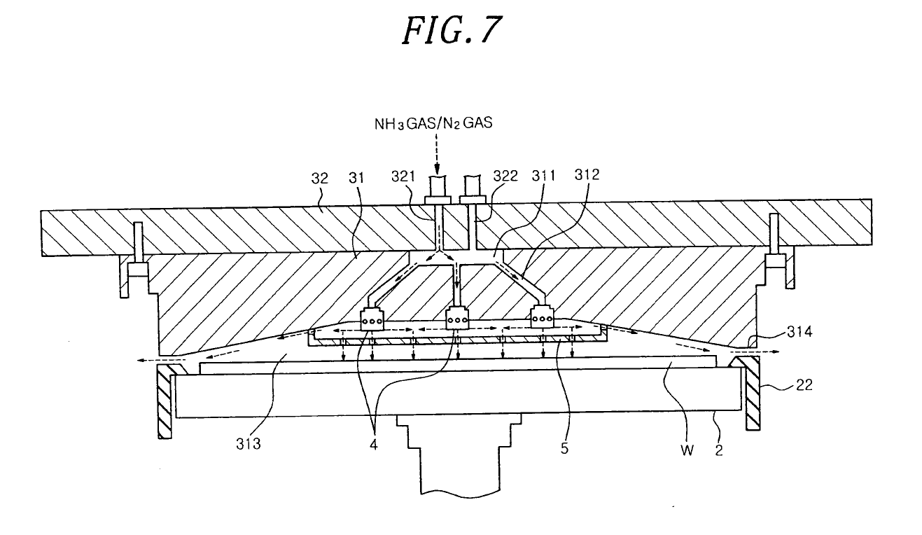

Hereinafter, the operation of the film forming apparatus will be described with reference to FIGS. 6 and 7. First, an atmosphere in the processing chamber 1 is depressurized to a vacuum atmosphere and, then, the mounting table 2 is lowered to the transfer position. The gate valve 12 opens, and the transfer arm of the wafer transfer unit provided in the vacuum transfer chamber connected to the loading/unloading port 11 enters the processing chamber 1 to transfer the wafer W to and from the supporting pins 25. Next, the supporting pins 25 are lowered, and the wafer W is mounted on the mounting table 2 heated to the aforementioned film formation temperature by the heater 21.

Next, the gate valve 12 is closed and the mounting table 2 is raised to the processing position. Then, a titanium chloride gas is supplied from a titanium chloride gas supply unit 64 after adjusting the pressure in the processing chamber 1 (see FIG. 6). The supplied titanium chloride gas flows into the gas supply unit 4 through the titanium chloride gas supply hole 322, the diffusion space 311, and the gas supply paths 312.

The titanium chloride gas flowing into the gas supply unit 4 is introduced into the shower head 5 through the gas discharge openings 42 and supplied into the processing space 313 through the gas supply openings 511 and 521 formed at the shower head 5.

The titanium chloride gas supplied into the processing space 313 through the gas supply openings 521 of the sidewall portion 52 is guided along the inclined surface of the ceiling portion of the processing space 313 and diffused radially in a diametrical direction from the central portion to the peripheral portion of the ceiling plate 31. Further, the titanium chloride gas is diffused downward and adsorbed onto the wafer W on the mounting table 2 when it is brought into contact with the surface of the wafer W.

Meanwhile, the titanium chloride gas supplied through the gas supply openings 511 of the bottom portion 51 is lowered in the processing space 313 to reach the wafer W on the mounting table 2, and a part thereof is adsorbed onto the wafer W. The remaining titanium chloride gas is diffused radially in a diametrical direction along the surface of the wafer W, and a part thereof is adsorbed onto the surface of the wafer W. The titanium chloride gas flowing along the surface of the wafer W joins with the titanium chloride gas supplied through the gas supply openings 521 of the sidewall portion 52.

The titanium chloride gas, which has reached the gap between the rim 314 and the cover member 22 after flowing through the processing space 313, flows into the processing chamber 1 and then is discharged to the outside through the gas exhaust duct 13.

In the above flow, due to the gradually widening inclined surface formed at the bottom surface of the ceiling plate 31, the titanium chloride gas is hardly formed and the titanium chloride gas supplied to the processing space 313 can be efficiently supplied onto the surface of the wafer W.

Next, the supply of the titanium chloride gas is stopped, and the nitrogen gas as a replacement gas is supplied from the nitrogen gas supply unit 63 (see FIG. 6). The nitrogen gas is supplied into the processing space 313 in the same route as that of the titanium chloride gas, and the titanium chloride gas in the corresponding route and the processing space 313 is replaced with the nitrogen gas.

In this manner, the nitrogen gas is supplied for a predetermined period of time and the gas substitution is performed. Then, the supply of the nitrogen gas is stopped, and the ammonia gas is supplied from the ammonia gas supply unit 62 (see FIG. 7). The supplied ammonia gas flows into the gas supply unit 4 through the ammonia gas supply hole 321, the diffusion space 311, and the gas supply paths 312. Further, the ammonia gas discharged into the shower head 5 from the gas supply unit 4 is supplied into the processing space 313 in the same flow as that of the titanium chloride gas.

When the ammonia gas flowing in the processing space 313 reaches the surface of the wafer W, first, the components of the titanium chloride gas adsorbed onto the wafer W is nitrided to form titanium nitride. Then, the gas supplied into the gas supply paths 312 is switched to nitrogen gas for replacement from the nitrogen gas supply unit 61, and the ammonia gas in the processing space 313 and the ammonia gas supply path is replaced with the nitrogen gas (see FIG. 7).

In this manner, a molecular layer of TiN is laminated on the surface of the wafer W by supplying the reactant gases (titanium chloride gas and ammonia gas) and the replacement gas (nitrogen gas) in the order of the titanium chloride gas→the nitrogen gas→the ammonia gas→the nitrogen gas, thereby forming a titanium nitride film.

The operations of the gas supply units 4 and the shower head 5 in supplying the reactant gases and the replacement gas will be described. First, the gases supplied to the gas supply units 4 through the gas supply paths 312 are discharged to the space in the shower head 5 through the gas discharge openings 42 of the head portion 41 to be diffused horizontally. At this time, the gas supply units 4 circumferentially arranged are spaced apart from the inner wall surface of the sidewall portion 52 by the distance d, so that a part of the gas discharged through the gas discharge openings 42 reaches the sidewall portion 52 after the flow speed thereof is sufficiently decreased. Meanwhile, the remaining part of the gas discharged through the gas discharge openings 42 reaches the bottom portion 51 after the flow direction thereof is changed downward toward the shower head 5. The gas that has reached the bottom portion 51 and the sidewall portion 52 is uniformly supplied into the processing space 313 through the gas supply openings 511 and 521 radially outwardly and downwardly when seen from the shower head 5 (see FIGS. 5 to 7).

Since the flow speeds of the gases discharged from the gas supply units 4 are sufficiently decreased in the shower head 5 and, then, the gases are distributed to the processing space 313 through the gas supply openings 511 and 521, the flow speeds of the reactant gases (titanium chloride gas and ammonia gas) discharged through the gas supply openings 511 and 521 are decreased. As a result, the flow speeds of the reactant gases that have reached the surface of the wafer W are low, and the in-plane uniformity of the film thickness is improved.

Meanwhile, when the replacement gas (nitrogen gas) is supplied, the period of time required for the gas replacement is short because the area of the bottom portion 51 is smaller than that of the wafer W and the volume in the shower head 5 is small due to a small size thereof. Further, a gradually widening inclined surface is formed at the bottom surface (ceiling surface) of the ceiling plate 31 outside the shower head 5. The processing space 313 is smaller compared to the case where the ceiling surface is flat, and an angular space where the gas is stagnated by a vortex flow does not exist. Therefore, the period of time required for the replacement of the gas in the processing space 313 can be shortened.

After a titanium nitride film having a desired film thickness is formed by repeating the supply of the titanium chloride gas and the ammonia gas, e.g., several tens of times to several hundreds of times, the last ammonia gas is discharged by supplying nitrogen gas for replacement and, then, the mounting table 2 is lowered to the transfer location. Then, the gate valve 12 opens to allow the introduction of the transfer arm, and the wafer W is transferred to the transfer arm from the supporting pins 25 in the reverse sequence of the loading operation. After the wafer W that has been subjected to film formation is unloaded, a next wafer is loaded.

The film forming apparatus of the present embodiment provides the following effects. The shower head 5 smaller than the wafer W as a film formation target is used, and a plurality of the gas supply units 4 is provided at an inner side of the shower head 5. Therefore, the replacement between the reactant gases and the replacement gas can be performed in a short period of time. Moreover, the shower head 5 is provided at the central region of the ceiling member 31 (ceiling portion) having an inclined surface that is gradually wider from the center to the periphery, so that the volume of the processing space 313 where the wafer W is brought into contact with the reactant gases becomes smaller and the stagnation of the gas hardly occurs. In this case as well, a period of time required for replacement of the reactant gases can be shortened.

Each of the gas supply units 4 has a plurality of the gas discharge openings 42 for diffusing a gas horizontally, and is spaced apart from the inner wall surface of the sidewall portion 52 by the distance d. Therefore, the reactant gases are uniformly supplied from the entire surface of the shower head 5, and the in-plane uniformity of the thickness of the film formed on the wafer W can be improved.

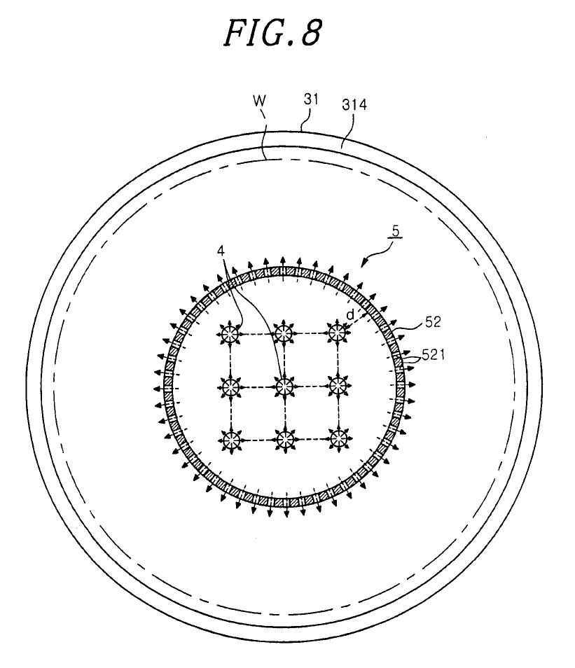

Here, the arrangement of the gas supply units 4 in the shower head 5 is not limited to the example in which the gas supply units 4 arranged circumferentially around the central gas supply unit 4 as shown in FIG. 5. For example, the gas supply units 4 may be arranged in the pattern of dots on a checkerboard, as shown in FIG. 8. Further, in the arrangement example shown in FIGS. 5 and 8, the central gas supply unit 4 may not be provided. In the arrangement example shown in FIG. 8, the gas supply units 4 disposed near the sidewall portion 52 are preferably spaced apart from the inner wall surface of the sidewall portion 52 by a distance greater than or equal to the distance d.

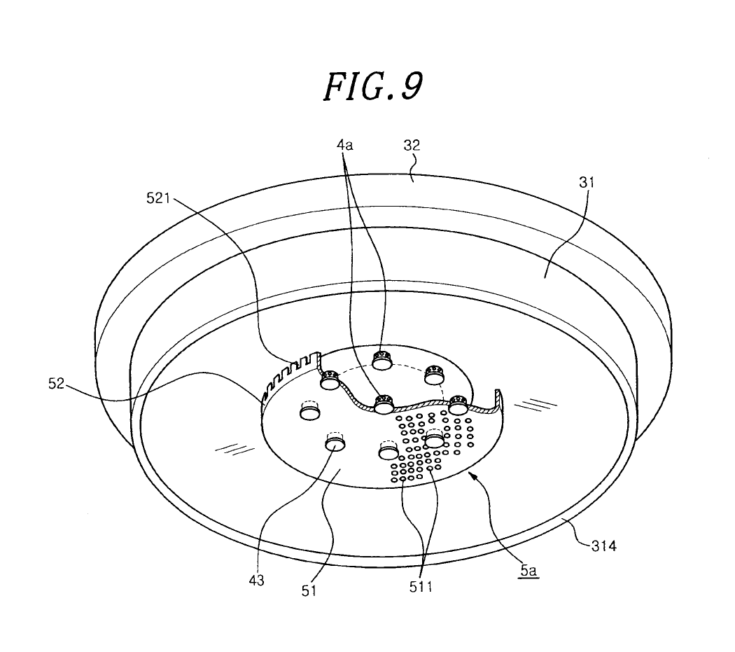

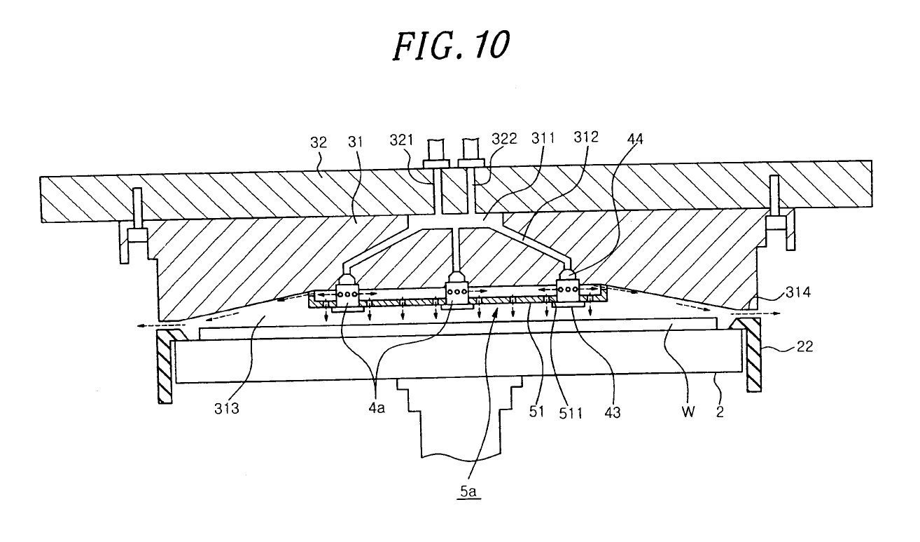

Next, FIGS. 9 and 10 show an example in which the replacement of the reactant gases is improved by further decreasing the diameter and the height of a shower head 5a. In this example, lower end portions of gas supply units 4a penetrate through a bottom portion 51 of the shower head 5a, and the shower head 5a is held by the gas supply units 4a. Specifically, wider head portions 43 having a circular plate shape are provided at the respective lower end portions of the gas supply units 4a, and the bottom portion 51 of the shower head 5a is held from below by the head portions 43. Meanwhile, each of upper end portions of the gas supply units 4a has a male screw portion 44. By screw-coupling the gas supply units 4a holding the shower head 5a to female screw portions formed in the gas supply paths 312, the ceiling plate 31 is fixed to the shower head 5a.

When nine gas supply units 4a are disposed as shown in FIG. 9, the shower head 5a has a diameter of 116 mm (radius 58 mm); a vertical distance from the bottom surface of the flat region of the ceiling plate 31 to the top surface of the bottom portion 51 is set to 4 mm; and a volume in the shower head 5a except a volume of the gas supply units 4a is set to 37 cm³.

As will be described in the following test examples, a film having a uniform film thickness can be formed in the case of using the shower head 5 having a larger diameter of the bottom portion 51 than in the case of using the shower head 5a having a smaller diameter of the bottom portion 51. On the other hand, the shower head 5a having a smaller size can provide rapid replacement and reduce a period of time required for substitution the film formation. Therefore, the size of the shower head 5 is determined in consideration of a demand for in-plane uniformity of a film to be formed and a film formation time.

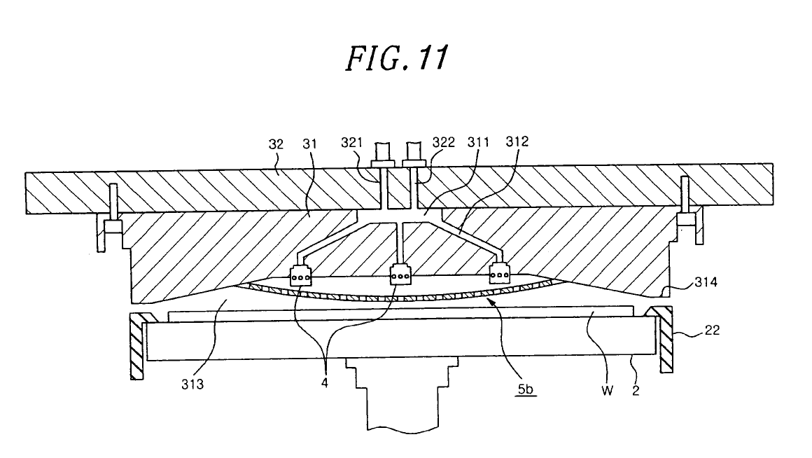

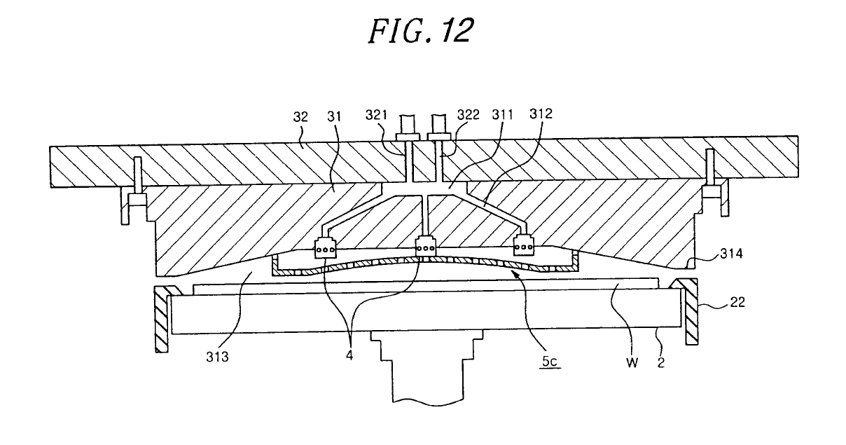

The bottom portion 51 is not limited to a flat plate, and a shower head 5b may be formed to have a round shape convexed downward as shown in FIG. 11. Or, a shower head 5c having a recess when seen from the wafer W as shown in FIG. 12 may be used to reduce the volume in the shower head 5c.

In addition, the configuration of the gas discharge port 42 provided at the head portion 41 of the gas supply unit 4 is not limited to that illustrated in FIG. 4. For example, a single slit extending in the circumferential direction of the side wall of the head portion 41 may be formed, and the slit may be covered by a mesh member. Further, it is not necessary to provide the head portion 41 to the gas supply unit 4. For example, the gas supply path 312 may be formed in a spiral shape or the like so that the gas from the gas supply path 312 is discharged into the shower head 5 while forming a vortex flow. In that case as well, the gas discharged while forming the vortex flow is diffused into the shower head 5 horizontally and then uniformly supplied into the processing space 313 through the gas supply openings 511 and 512 in a state where the flow speed thereof has been decreased.

In addition, the shape of the ceiling plate 31 is not limited to the example shown in FIGS. 1 and 2. For example, the shower head 5 may be formed at the inclined surface that becomes wider from the center to the periphery of the recess without providing the central a flat region of the recess. Further, the ceiling plate 31 having no rim 314 may be used.

The film forming apparatus of the present invention may form, other than the aforementioned TiN film, a film containing a metal element, e.g., Al, Si or the like as an element of group 3 of the periodic table, Ti, Cr, Mn, Fe, Co, Ni, Cu, Zn, Ge or the like as an element of group 4 of the periodic table, Zr, Mo, Ru, Rh, Pd, Aq or the like as an element of group 5 of the periodic table, and Ba, Hf, Ta, W, We, Ir, Pt or the like as an element of group 6 of the periodic table. As for the metal material to be adsorbed onto the surface of the wafer W, an organic or an inorganic metal compound of the above metal elements may be used as a reaction gas (source gas). Specific example of the metallic material include, other than the aforementioned TiCl₄, BTBAS (bis(tertiary-butylamino)silane), DCS (dichlororosilane), HCD (hexachlorodisilane), TMA (trimethylaluminum), 3DMAS (tris dimethylamino silane) and the like.

The reaction for obtaining a desired film by reacting the source gas adsorbed onto the surface of the wafer W includes various reactions, e.g., an oxidation reaction using O₂, O₃, H₂O, or the like, a reduction reaction using H₂, an organic acid such as HCOOH, CH₃COOH or the like, or an alcohol such as CH₃OH, C₂H₅OH or the like, a carbonization reaction using CH₄, C₂H₆, C₂H₄, C₂H₂ or the like, and a nitriding reaction using NH₃, NH₂NH₂, N₂, or the like.

As for the reactant gases, three types or four types of reactant gases may be used. For example, when three types of reactant gases are used, a film of strontium titanate (SrTiO₃) may be formed. For example, there are used Sr(THD)₂ (strontium bis tetramethyl heptanedionate) as an Sr material, Ti (OiPr)₂(THD)₂(titanium bis isopropoxide bis tetramethyl heptanedionate) as a Ti material, and ozone gas as an oxidizing gas are used. In that case, the gases are switched in the order of Sr source gas→replacement gas→oxidizing gas→replacement gas→Ti source gas→replacement gas→oxidizing gas→replacement gas. Although a circular wafer W has been described as a substrate to be subjected to film formation, the present invention may be applied to a rectangular glass substrate (LCD substrate).

### TEST EXAMPLES

(Experiment)

By using ceiling plates 31 of different types, titanium chloride gas and an ammonia gas is supplied into the processing space 313 to form a titanium nitride film, and the in-plane uniformity thereof was measured.

A. Experimental Conditions

### Test Example 1

A titanium nitride film was formed by using the ceiling plate 31 having the gas supply units 4 and the shower head 5 shown in FIGS. 2 and 5. The configuration of the shower head 5 will be described again. The shower head 5 has a diameter of 166 mm (radius of 83 mm); a vertical distance from the bottom surface of the flat region of the ceiling plate 31 to the top surface of the bottom portion 51 is set to 8.5 mm; and a volume in the shower head 5 excluding a volume of the gas supply units 4 is set to 146.5 cm³. The titanium chloride gas was supplied at a flow rate of 50 sccm for 0.05 sec; the ammonia gas was supplied at a flow rate of 2700 sccm for 0.3 sec; and the nitrogen gas was supplied at a flow rate of 6 L for every replacement operation.

Further, the film thickness of the formed film was measured by film thickness gauge of a spectroscopic ellipsometry type, and the in-plane uniformity (M−m value) was measured by the following Eq. (1).

(M−m value)={(maximum film thickness(M value)−minimum film thickness(m value))/(2×average film thickness)}×100(%) (1)

### Test Example 2

A titanium nitride film was formed by using a small sized shower head 5a shown in FIG. 10 instead of the shower head 5 described in Test Example 1. Then, the in-plane uniformity was calculated by the method used in Test Example 1. The configuration of the shower head 5a will be described again. The shower head 5a has a diameter of 116 mm (radius of 58 mm); a vertical distance from the bottom surface of the flat region of the ceiling plate 31 to the top surface of the bottom portion 51 is set to 4 mm; and a volume in the shower head 5 excluding a volume of the gas supply units 4 is set to 37 cm³.

### Comparative Example 1

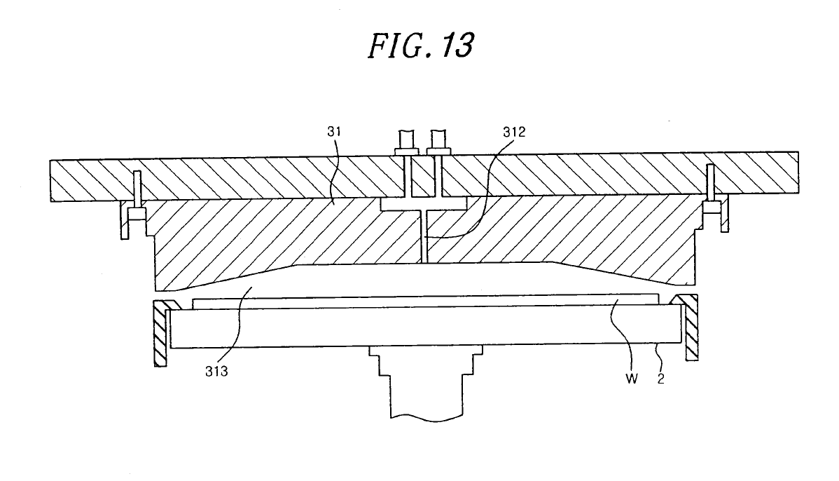

A film was formed by using the ceiling plate 31 having a single gas supply path 312 that opens at the central portion of the bottom surface as shown in FIG. 13, and the in-plane uniformity was calculated by the method used in Test Example 1.

B. Experimental Results

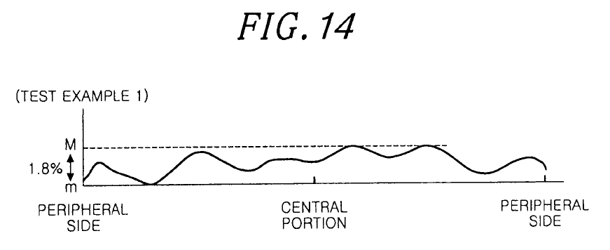

The displacement of the film thickness of the formed film in Test Examples 1 and 2 and Comparative Example 1 are shown in FIGS. 14 to 16, respectively. The horizontal axis in each graph indicates a position in a diametrical direction of the wafer W, and the vertical axis indicates a relative change of a film thickness to the M−m value.

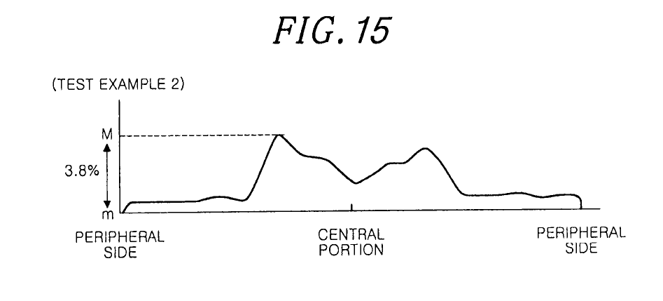

In accordance with the results shown in FIGS. 14 and 15, in Test Example 1 using the large sized shower head 5, the M−m value was 1.8%. Meanwhile, in Test Example 2 using the small sized shower head 5a, the M−m value was 3.8%. In both cases, the good in-plane uniformity of 5% or less was obtained. The comparison between Test Examples 1 and 2 shows that even if the number of the installed gas supply units 4 and the arrangement state thereof are the same, a film having good in-plane uniformity can be formed in Test Example 1 using the shower head 5 having the larger diameter than in Test Example 2 using the shower head 5a having the smaller diameter.

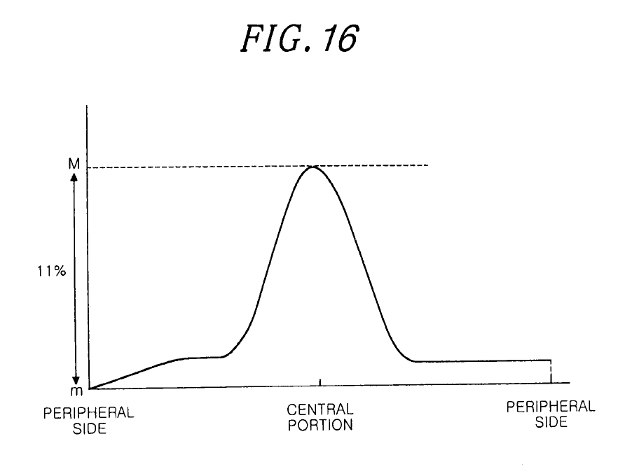

Meanwhile, in Comparative Example 1 in which a gas is supplied through the opening formed at the central portion of the ceiling plate 31, a mountain-shaped film thickness distribution in which a film thickness is thickest immediately below the opening through which the gas is supplied and becomes small abruptly toward the peripheral side of the wafer W as shown in FIG. 16 was obtained. The M−m value of Comparative Example 1 was 11%, which was more than twice the required value (5%). This is because the adsorption amounts of the source gas are different between the region where the reactant gases reach the wafer W at a high speed and the outer region thereof.

While the invention has been shown and described with respect to the embodiments, it will be understood by those skilled in the art that various changes and modification may be made without departing from the scope of the invention as defined in the following claims.

What is claimed is:

1. A film forming apparatus for performing a film forming process by supplying a plurality of types of reactant gases that react with one another to a substrate in a processing chamber in a vacuum atmosphere and supplying a replacement gas between supply of one of the reactant gases and supply of a next one of the reactant gases, the apparatus comprising:
a mounting table provided in the processing chamber, the mounting table serving to mount thereon a substrate;
a ceiling part provided to face the mounting table, the ceiling part having an inclined surface that is wider gradually from a center portion toward a periphery;
a plurality of gas supply units provided at a central area of the ceiling part, each of the gas supply units having gas discharge openings formed along a circumferential direction thereof;
a shower head disposed to cover the gas supply units from below, the shower head having a plurality of gas supply openings in a bottom portion thereof opposite to the mounting table; and
a gas exhaust unit configured to evacuate the processing chamber,
wherein an outer periphery of the shower head is located inward of an outer periphery of the substrate mounted on the mounting table.

2. The film forming apparatus of claim 1, wherein the gas discharge ports formed at the gas supply units are disposed such that a gas flowing through the gas discharge ports is diffused toward a central portion and a peripheral portion of the shower head when seen in a plan view.

3. The film forming apparatus of claim 1, wherein the number of the gas supply units is three or more, and the gas supply units are provided along a circumferential direction of the shower head.

4. The film forming apparatus of claim 2, wherein the number of the gas supply units is three or more, and the gas supply units are provided along a circumferential direction of the shower head.

5. The film forming apparatus of claim 1, wherein the shower head includes a sidewall portion provided along an outer periphery of the bottom portion opposite to the mounting table, and the sidewall portion has a plurality of gas supply openings for horizontally supplying a gas in a shower shape.

6. The film forming apparatus of claim 2, wherein the shower head includes a sidewall portion provided along an outer periphery of the bottom portion opposite to the mounting table, and the sidewall portion has a plurality of gas supply openings for horizontally supplying a gas in a shower shape.

7. The film forming apparatus of claim 1, wherein the substrate has a circular plate shape; the bottom portion has a circular shape when seen in a plan view; and on the assumption that a radius of the substrate is R and a radius of the bottom portion is r, r/R is greater than or equal to 4/15 and smaller than or equal to ⅔.

8. The film forming apparatus of claim 2, wherein the substrate has a circular plate shape; the bottom portion has a circular shape when seen in a plan view; and on the assumption that a radius of the substrate is R and a radius of the bottom portion is r, r/R is greater than or equal to 4/15 and smaller than or equal to ⅔.
